(19) United States
(12) Patent Application Publication
(10) Pub. No.: US 2014/0134509 A1
(43) Pub. Date: May 15, 2014

(54) DIRECT ALCOHOL FUEL CELL SYSTEM

(71) Applicants: Hirotaka Mizuhata, Osaka-shi (JP); Tomohisa Yoshie, Osaka-shi (JP); Mutsuko Yamamoto, Osaka-shi (JP); Shinobu Takenaka, Osaka-shi (JP); Takenori Onishi, Osaka-shi (JP); Masashi Muraoka, Osaka-shi (JP)

(72) Inventors: Hirotaka Mizuhata, Osaka-shi (JP); Tomohisa Yoshie, Osaka-shi (JP); Mutsuko Yamamoto, Osaka-shi (JP); Shinobu Takenaka, Osaka-shi (JP); Takenori Onishi, Osaka-shi (JP); Masashi Muraoka, Osaka-shi (JP)

(73) Assignee: c/o Sharp Kabushiki Kaisha, Osaka-shi, Osaka (JP)

(21) Appl. No.: 14/127,418

(22) PCT Filed: May 31, 2012
(86) PCT No.: PCT/JP2012/064106

§ 371 Date: Dec. 18, 2013

(30) Foreign Application Priority Data
Jun. 23, 2011 (JP) 2011-139256

(51) Int. Cl. H01M 8/04; H01M 8/10

(52) U.S. Cl. CPC H01M 8/04186; H01M 8/1011
USPC 429/431; 429/432

(57) ABSTRACT

A direct alcohol fuel cell system including a fuel cell unit having a direct alcohol fuel cell including an anode electrode, an electrolyte membrane, and a cathode electrode in this order, a fuel supply unit for supplying alcohol fuel to the anode electrode, a detecting unit for detecting a current value I of a current flowing between the anode electrode and the cathode electrode of the direct alcohol fuel cell or an output voltage value V of the direct alcohol fuel cell, and a temperature T of the direct alcohol fuel cell, and a control unit for determining a supply quantity Q of alcohol fuel to the anode electrode based on detection results of the current value I or the output voltage value V, and the temperature T and controlling the fuel supply unit so that the supply quantity of the alcohol fuel is adjusted to the supply quantity Q.

### TECHNICAL FIELD

The present invention relates to a direct alcohol fuel cell system which includes a direct alcohol fuel cell using an alcohol or an aqueous alcohol solution as fuel.

### BACKGROUND ART

In recent years, expectations for the practical use of a fuel cell as a novel power source of portable electronic equipment have increased. Particularly, direct alcohol fuel cells using an alcohol or an aqueous alcohol solution as fuel easily realize simplification of a fuel cell structure and conserving space, because a fuel storage chamber can be designed relatively simple as compared to a case in which gas is used as fuel. Thus, the direct alcohol fuel cells are particularly highly expected to serve as small fuel cells designed to be applied to portable electronic equipment.

In direct alcohol fuel cells using a cation-exchange membrane as an electrolyte membrane, electric power is drawn by the following electrochemical reaction (hereinafter, also referred to as the cell reaction). That is, when fuel (an alcohol or an aqueous alcohol solution) is supplied to an anode electrode, the fuel is oxidized by a catalytic reaction expressed by the following Expression (a):

anode electrode: CH₂OH+H₂O→CO₂↑+6H⁺+6e⁻,

when using, for example, methanol as an alcohol. Thus, carbon dioxide gas and protons are generated. The protons generated on the anode electrode side are transferred to a cathode electrode through the electrolyte membrane.

Meanwhile, in the cathode electrode, the protons transferred from the anode electrode and the oxygen in the air which is supplied to the cathode electrode cause a reduction reaction expressed by the following Expression (b):

cathode electrode: 3/2O₂+6H⁺+6e⁻→3H₂O,

and thus water is generated.

Hitherto, regarding the operation of a fuel cell, the quantity of fuel (fuel supply quantity) to be supplied to an anode electrode has been adjusted in accordance with the quantity of the cell reaction (in other words, an amount of current drawn from the fuel cell) in order to increase fuel use efficiency (the ratio of the quantity of fuel contributing to the cell reaction to the quantity of fuel supplied to the anode electrode). For example, Japanese Unexamined Patent Application Publication No. 2005-025959 (PTL 1) describes a method of operating a fuel cell in which a supply quantity of an aqueous methanol solution as fuel is controlled in response to a current value drawn from a direct methanol fuel cell.

In Japanese Patent No. 4407879 (PTL 2), there is a description that the power generation quantity is optimized by detecting the temperature of a direct methanol fuel cell and by adjusting supply quantities of fuel and air based on the detected temperature, rather than by adjusting a fuel supply quantity in response to a current value.

### CITATION LIST

### Patent Literature

PTL 1: Japanese Unexamined Patent Application Publication No. 2005-025959
PTL 2: Japanese Patent No. 4407879

### SUMMARY OF INVENTION

### Technical Problem

In the case of a direct alcohol fuel cell, it is important to be able to supply alcohol fuel neither too much nor too less in a quantity required for drawing an amount of current corresponding to a quantity of electric power demanded by electronic equipment connected to the fuel cell (in a quantity required for the cell reaction), in order to realize a stable operation of the fuel cell and an improvement in the fuel use efficiency. If the fuel is supplied only in a quantity less than the quantity required for the cell reaction, the stable operation of the fuel cell is disrupted by a fuel shortage (for example, the temperature and the output voltage of the fuel cell during the operation may be significantly reduced). On the other hand, if the fuel is supplied in an excessive quantity exceeding the quantity required for the cell reaction, the quantity of a so-called “crossover” in which the fuel is permeated to the cathode electrode side through an electrolyte membrane and is oxidized increases, and as a result, thermal runaway occurs due to a positive feedback in which the temperature of the fuel cell rises and the crossover quantity further increases, and thus the stable operation of the fuel cell is disrupted. In addition, the fuel use efficiency is also reduced due to an increase in the crossover quantity.

The method of the above-described PTL 1 has advantages in terms of an improvement in the fuel use efficiency during the time period of initial power generation. However, even when the fuel supply quantity is optimally controlled in response to a current value drawn from the fuel cell, the temperature of the fuel cell rises due to the fuel cell reaction and a small crossover quantity. As a result, the crossover quantity gradually increases and the fuel required for the cell reaction becomes gradually insufficient. Thus, there are problems in that the stable operation of the fuel cell is disrupted and the fuel use efficiency is gradually reduced due to the increase in the crossover quantity.

The invention is contrived to solve the above-described problems, and an object thereof is to provide a fuel cell system which can realize both of a stable operation of a direct alcohol fuel cell and an improvement in the fuel use efficiency.

### Solution to Problems

The inventors of the invention have found that the above-described problems can be solved by controlling a quantity of fuel to be supplied to an anode electrode in consideration of the fact that: crossover of the fuel necessarily occurs in a direct alcohol fuel cell; and the crossover quantity depends on the temperature of the fuel cell. That is, the invention includes the following aspects.

(a) A direct alcohol fuel cell system including a fuel cell unit which includes a direct alcohol fuel cell including an anode electrode, an electrolyte membrane, and a cathode electrode in this order, a fuel supply unit for supplying alcohol fuel to the anode electrode, a detecting unit for detecting a current value I of a current flowing between the anode electrode and the cathode electrode of the direct alcohol fuel cell or an output voltage value V of the direct alcohol fuel cell, and a temperature T of the direct alcohol fuel cell, and a control unit for determining a supply quantity Q of alcohol fuel to the anode electrode based on detection results of the current value I or the output voltage value V, and the temperature T and controlling the fuel supply unit so that the supply quantity of the alcohol fuel is adjusted to the supply quantity Q.

(b) The direct alcohol fuel cell system according to (a), in which the detecting unit can further detect a variation ΔT of the temperature T per unit time, and when at least one of the temperature T and the variation ΔT which are detected after the fuel supply unit is controlled so that the supply quantity of the alcohol fuel is adjusted to the supply quantity Q is out of a predetermined range, the control unit controls the fuel supply unit to change the supply quantity of the alcohol fuel from the supply quantity Q so that the temperature T and the variation ΔT are within the predetermined ranges.

(c) The direct alcohol fuel cell system according to (a), further including: an oxidant supply unit for supplying oxidant gas to the cathode electrode, in which the detecting unit can further detect a variation ΔT of the temperature T per unit time, the control unit can further control the adjustment of the supply quantity of the oxidant gas to the cathode electrode by the oxidant supply unit, and when at least one of the temperature T and the variation ΔT which are detected after the fuel supply unit is controlled so that the supply quantity of the alcohol fuel is adjusted to the supply quantity Q is out of a predetermined range, the control unit controls the fuel supply unit to change the supply quantity of the alcohol fuel from the supply quantity Q so that the temperature T and the variation ΔT are within the predetermined ranges, and/or controls the oxidant supply unit to change the supply quantity of the oxidant gas.

(d) The direct alcohol fuel cell system according to any one of (a) to (c), in which the control unit determines the supply quantity Q of the alcohol fuel in accordance with the following Expression [1]:

Q=a₁×I+F(T)

(where a₁ represents a positive number, and F(T) represents a function of the temperature T which satisfies dF(T)/dT>0) or the following Expression [2]:

Q=F′(V)+F(T)

(where F′(V) represents a function of the output voltage value V which satisfies dF′(V)/dV<0, and F(T) represents a function of the temperature T which satisfies dF(T)/dT>0).

(e) The direct alcohol fuel cell system according to any one of (a) to (c), in which the control unit determines the supply quantity Q of the alcohol fuel in accordance with the following Expression [3]:

Q=a₂×I+F(T,I)

(where a₂ represents a positive number, and F(T, I) represents functions of the temperature T and the current value I which satisfy dF(T, I)/dT>0 and dF(T, I)/dI<0) or the following Expression [4]:

Q=F′(V)+F(T,V)

(where F′(V) represents a function of the output voltage value V which satisfies dF′(V)/dV<0, and F(T, V) represents functions of the temperature T and the output voltage value V which satisfy dF(T, V)/dT>0 and dF(T, V)/dV>0).

(f) The direct alcohol fuel cell system according to any one of (a) to (e), in which the alcohol fuel is methanol or an aqueous solution thereof, and the oxidant gas is the air.

The fuel cell unit may include two or more direct alcohol fuel cells electrically connected in series or in parallel.

### Advantageous Effects of Invention

According to the invention, it is possible to realize both a stable operation of a direct alcohol fuel cell and an improvement in the fuel use efficiency.

### BRIEF DESCRIPTION OF DRAWINGS

FIG. 1 is a schematic diagram illustrating an example of the configuration of a direct alcohol fuel cell system according to the invention.

FIG. 2 illustrates schematic cross-sectional views illustrating preferable examples of a direct alcohol fuel cell which is used in the direct alcohol fuel cell system according to the invention.

FIG. 3 is a flowchart illustrating an example of the control of an alcohol fuel supply quantity which is performed by the direct alcohol fuel cell system according to the invention.

FIG. 4 is a flowchart illustrating another example of the control of an alcohol fuel supply quantity which is performed by the direct alcohol fuel cell system according to the invention.

FIG. 5 is a flowchart illustrating a further example of the control of an alcohol fuel supply quantity which is performed by the direct alcohol fuel cell system according to the invention.

FIG. 6 is a schematic diagram illustrating another example of the configuration of the direct alcohol fuel cell system according to the invention.

FIG. 7 is a flowchart illustrating a further example of the control of an alcohol fuel supply quantity which is performed by the direct alcohol fuel cell system according to the invention.

FIG. 8 is a flowchart illustrating a further example of the control of an alcohol fuel supply quantity which is performed by the direct alcohol fuel cell system according to the invention.

FIG. 9 is a flowchart illustrating a further example of the control of an alcohol fuel supply quantity which is performed by the direct alcohol fuel cell system according to the invention.

FIG. 10 is a schematic top view illustrating a second layer of an intermediate layer which is used in Example 1.

FIG. 11 is a schematic top view illustrating a first layer of the intermediate layer which is used in Example 1.

FIG. 12 is a schematic top view illustrating an anode separator which is used in Example 1.

### DESCRIPTION OF EMBODIMENTS

Hereinafter, the invention will be described in detail with embodiments.

### First Embodiment

### [a] Configuration of Direct Alcohol Fuel Cell System

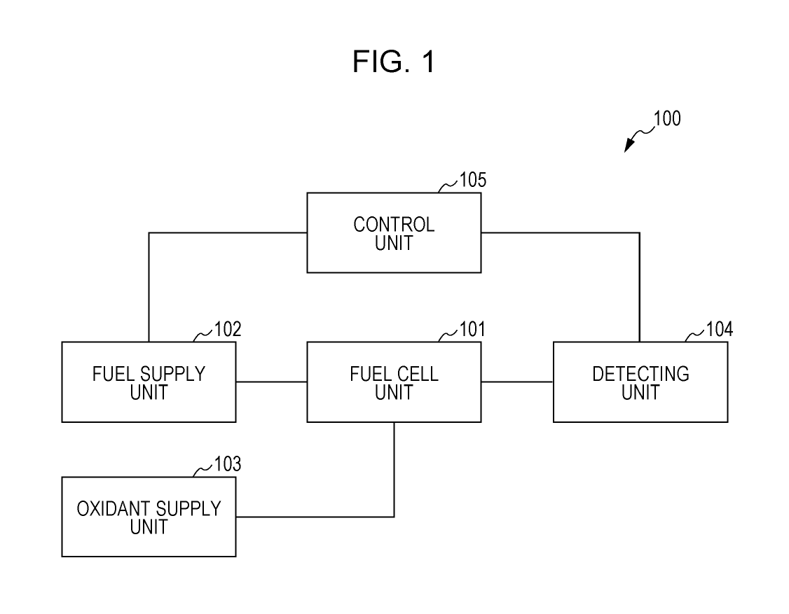

FIG. 1 is a schematic diagram illustrating the configuration of a direct alcohol fuel cell system according to this embodiment. A fuel cell system 100 illustrated in FIG. 1 includes a fuel cell unit 101 which includes a direct alcohol fuel cell; a fuel supply unit 102 which is connected to the fuel cell unit 101 and supplies alcohol fuel to an anode electrode of the direct alcohol fuel cell; an oxidant supply unit 103 which is connected to the fuel cell unit 101 and supplies oxidant gas to a cathode electrode of the direct alcohol fuel cell; a detecting unit 104 which is connected to the fuel cell unit 101 and detects a current value I of a current flowing between the anode electrode and the cathode electrode of the direct alcohol fuel cell or an output voltage value V of the direct alcohol fuel cell, and a temperature T of the direct alcohol fuel cell; and a control unit 105 which is connected to the fuel supply unit 102 and the detecting unit 104, determines a supply quantity Q of alcohol fuel to the anode electrode based on the detection results of the current value I or the output voltage value V, and the temperature T, and controls the fuel supply unit 102 so that the supply quantity of the alcohol fuel is adjusted to the supply quantity Q.

As will be described later, the direct alcohol fuel cell system 100 of this embodiment determines the supply quantity Q of alcohol fuel to the anode electrode in accordance with any of Expressions [1] to [4] and performs control so that the supply quantity of the alcohol fuel is adjusted to the supply quantity Q. Expressions [1] to [4] are expressions which derive, as the supply quantity Q, a minimum alcohol fuel quantity required for a cell reaction based on the considerations that crossover of the fuel occurs and a crossover quantity increases with a rise in temperature. Therefore, when the alcohol fuel supply quantity is controlled based on the expressions, the alcohol fuel can be supplied neither too much nor too less in a quantity required for the cell reaction. Accordingly, the fuel cell can be stably operated and fuel use efficiency can be improved. The improvement in the fuel use efficiency is also advantageous in reducing the size of the fuel cell.

(Fuel Cell Unit)

The fuel cell unit 101 is formed of a direct alcohol fuel cell. The direct alcohol fuel cell includes, as a main power generation unit, a membrane electrode assembly (MEA) having an anode electrode, an electrolyte membrane, and a cathode electrode in this order.

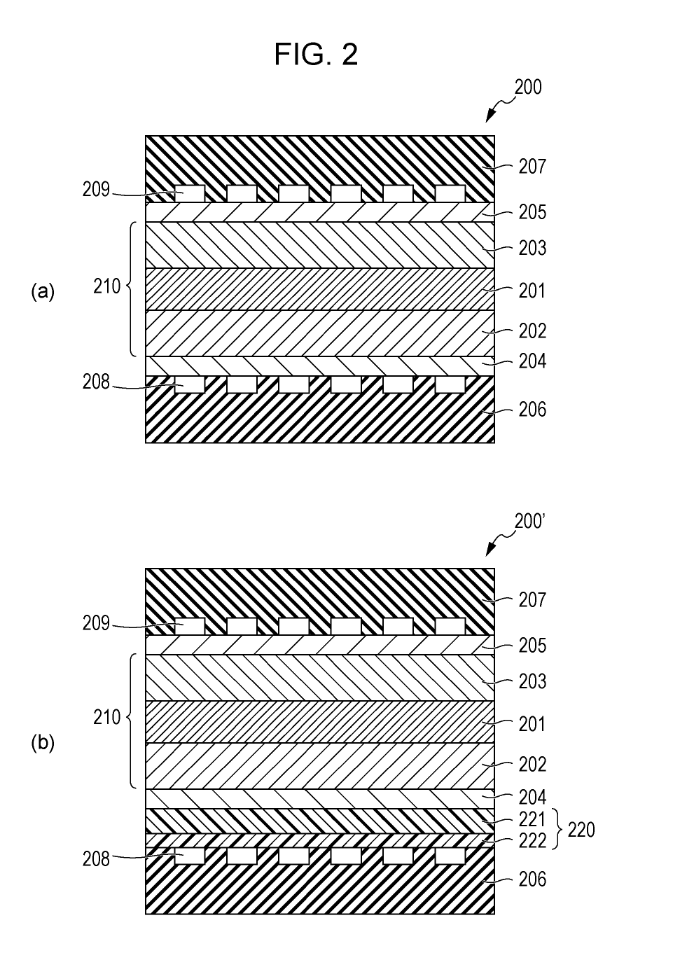

FIG. 2(a) is a schematic cross-sectional view illustrating a preferable example of the direct alcohol fuel cell which is used in the fuel cell system of the invention, and illustrates a single cell structure of the direct alcohol fuel cell. A direct alcohol fuel cell 200 illustrated in FIG. 2(a) includes a membrane electrode assembly (MEA) 210 having an anode electrode 202, an electrolyte membrane 201, and a cathode electrode 203 in this order; an anode collector layer 204 which is stacked on an outer surface of the anode electrode 202; a cathode collector layer 205 which is stacked on an outer surface of the cathode electrode 203; an anode separator 206 which is stacked on an outer surface of the anode collector layer 204; and a cathode separator 207 which is stacked on an outer surface of the cathode collector layer 205. Surfaces on the collector layer sides of the anode separator 206 and the cathode separator 207 are respectively provided with a fuel channel 208 for supplying alcohol fuel to the anode electrode 202 and an oxidant gas channel 209 for supplying oxidant gas to the cathode electrode 203.

(1) Electrolyte Membrane

The electrolyte membrane 201 has a function of transferring protons from the anode electrode 202 to the cathode electrode 203 and a function of preventing short circuit with an electrical insulation property between the anode electrode 202 and the cathode electrode 203. The material of the electrolyte membrane 201 is not particularly limited as long as the material has protonic conductivity and an electrical insulation property. A polymeric membrane, an inorganic membrane, or a composite membrane can be used. Examples of the polymeric membrane include Nafion (registered trademark, manufactured by DuPont), Aciplex (registered trademark, manufactured by Asahi Kasei Corporation), and Flemion (registered trademark, manufactured by Asahi Glass Co., Ltd.), which are perfluorosulfonic acid electrolyte membranes. A membrane formed from a styrene graft polymer, a membrane formed from a trifluorostyrene derivative copolymer, or a hydrocarbon electrolyte membrane formed from sulfonated polyarylene ether, sulfonated polyetheretherketone, sulfonated polyimide, sulfonated polybenzimidazole, phosphonated polybenzimidazole, sulfonated polyphosfazen, or the like can also be used.

Examples of the inorganic membrane include a membrane formed from phosphate glass, cesium hydrogensulfate, polytungstophosphoric acid, ammonium polyphosphate, or the like. Examples of the composite membrane include a composite membrane of an inorganic material such as tungstic acid, cesium hydrogensulfate, or polytungstophosphoric acid and an organic material such as polyimide, polyetheretherketone, or perfluorosulfonic acid. The electrolyte membrane 201 has a thickness of, for example, 1 μm to 200 μm.

(2) Anode Electrode and Cathode Electrode

The anode electrode 202 which is formed on one surface of the electrolyte membrane 201 and the cathode electrode 203 which is formed on the other surface thereof are provided with at least a catalyst layer (an anode catalyst layer and a cathode catalyst layer, respectively) formed of a porous layer containing a catalyst (an anode catalyst and a cathode catalyst, respectively) and an electrolyte (an anode electrolyte and a cathode electrolyte, respectively). These catalyst layers are stacked to contact with the surfaces of the electrolyte membrane 201.

The anode catalyst catalyzes a reaction in which protons and electrons are generated from alcohol fuel, and the anode electrolyte has a function of conducting the generated protons to the electrolyte membrane 201. The cathode catalyst catalyzes a reaction in which water is generated from the protons conducted through the cathode electrolyte and oxidant gas (the air or the like). The anode catalyst and the cathode catalyst may be carried on a surface of a conductive material such as carbon and titanium, and is preferably carried on a surface of a conductive material such as carbon and titanium having a hydrophilic functional group such as a hydroxyl group and a carboxyl group.

The anode electrode 202 and the cathode electrode 203 may be provided with an anode gas diffusion layer and a cathode gas diffusion layer which are stacked on the anode catalyst layer and the cathode catalyst layer, respectively. These gas diffusion layers respectively have a function of diffusing the alcohol fuel which is supplied to the anode electrode 202 and the oxidant gas supplied to the cathode electrode 203 inside the surfaces and a function of sending/receiving electrons to/from the anode catalyst layer and the cathode catalyst layer.

The anode gas diffusion layer and the cathode gas diffusion layer may be conductive porous layers. Specifically, the anode gas diffusion layer and the cathode gas diffusion layer are preferably formed from a porous material formed of a carbon material; a conductive polymer; noble metals such as Au, Pt, and Pd; transition metals such as Ti, Ta, W, Nb, Ni, Al, Cu, Ag, and Zn; nitrides or carbides of these metals; alloys represented by stainless steel, which contain these metals; or the like, because the specific resistance is small and the voltage reduction is suppressed. When using a metal such as Cu, Ag, and Zn having poor corrosion resistance under an acidic atmosphere, such metal may be surface-treated (a membrane is formed thereon) with a corrosion-resistant noble metal such as Au, Pt, and Pd, a conductive polymer, a conductive nitride, a conductive carbide, a conductive oxide, or the like. More specifically, for example, foam metal, metal fabric, and metal sintered compact formed of the noble metal, transition metal, or alloy; carbon paper, carbon cloth, an epoxy resin membrane containing carbon particles, and the like can be preferably used as the anode gas diffusion layer and the cathode gas diffusion layer.

(3) Anode Collector Layer and Cathode Collector Layer

The anode collector layer 204 and the cathode collector layer 205 are members which are layered on the anode electrode 202 and the cathode electrode 203, respectively, have a power collection function, that is, a function of collecting electrons in the adjacent electrode, and generally also function as drawing electrodes for providing electrical wiring. The material of the anode collector layer 204 and the cathode collector layer 205 is preferably a metal because the specific resistance is small and the voltage reduction is suppressed even if the current is drawn in a surface direction, and more preferably an electron-conductive metal having corrosion resistance under an acidic atmosphere. Examples of the metal include noble metals such as Au, Pt, and Pd; transition metals such as Ti, Ta, W, Nb, Ni, Al, Cu, Ag, and Zn; nitrides or carbides of these metals; and alloys represented by stainless steel, which contain these metals. When using a metal such as Cu, Ag, and Zn having poor corrosion resistance under an acidic atmosphere, such metal may be surface-treated (a membrane is formed thereon) with a corrosion-resistant noble metal such as Au, Pt, and Pd, a conductive polymer, a conductive nitride, a conductive carbide, a conductive oxide, or the like. The anode electrode 202 and the cathode electrode 203 can be electrically connected by electrically connecting the anode collector layer 204 and the cathode collector layer 205.

More specifically, the anode collector layer 204 may be a mesh- or punching metal-shaped flat plate which is formed from the metal material and is provided with a plurality of through holes (openings) penetrating therethrough in a thickness direction to introduce the alcohol fuel flowing through the fuel channel 208 to the anode electrode 202. Similarly, the cathode collector layer 205 may be a mesh- or punching metal-shaped flat plate which is formed from the metal material and is provided with a plurality of through holes (openings) penetrating therethrough in a thickness direction to supply the oxidant gas (the air or the like) to the cathode electrode 203.

When the anode gas diffusion layer and the cathode gas diffusion layer are formed from a metal or the like and the conductivity is thus relatively high, or when a power collection function is imparted to the anode separator 206 and the cathode separator 207, which will be described later, the anode collector layer 204 and the cathode collector layer 205 may be omitted.

(4) Anode Separator and Cathode Separator

As illustrated in FIG. 2(a), the direct alcohol fuel cell 200 is provided with the anode separator 206 which is disposed on the anode collector layer 204 to introduce alcohol fuel to the anode electrode 202 and the cathode separator 207 which is disposed on the cathode collector layer 205 to introduce oxidant gas to the cathode electrode 203.

The anode separator 206 and the cathode separator 207 may be provided with a channel (the fuel channel 208 and the oxidant gas channel 209, respectively) formed of a groove for allowing alcohol fuel or oxidant gas to flow to the surface on the collector layer side. The channel may be formed of one or more grooves, and the shape thereof is not particularly limited. The channel may have a line shape, a serpentine shape, or the like.

The material of the anode separator 206 and the cathode separator 207 is not particularly limited, and examples thereof include conductive materials such as a carbon material, a conductive polymer, various metals, and alloys represented by stainless steel, and non-conductive materials such as various plastic materials. When a power collection function is imparted, a conductive material is used. In this case, the anode electrode 202 and the cathode electrode 203 can be electrically connected by electrically connecting the anode separator 206 and the cathode separator 207. When using, as the oxidant gas, the air in the atmosphere, the air can be directly taken from the cathode electrode side using a blower or the like, or taken in a passive manner through natural diffusion of the air without using an auxiliary machine such as a blower. In such a case, the cathode separator 207 which provides the oxidant gas channel can be omitted.

(5) Intermediate Layer

As in a direct alcohol fuel cell 200′ illustrated in FIG. 2(b), an intermediate layer 220 may be disposed between the anode collector layer 204 and the anode separator 206. The intermediate layer 220 may be formed of only a first layer 221 having a gas-liquid separation function, or may have a two-layer structure in which the first layer 221 and a second layer 222 are combined.

The first layer 221 is a hydrophobic porous layer having vaporized fuel permeability (a property of permeating a vaporized component in the liquid fuel) and liquid fuel impermeability, and is a layer having a gas-liquid separation function which allows fuel to be supplied to the anode electrode 202 in a vaporized manner. When the intermediate layer 220 is formed of only the first layer 221, the first layer 221 is disposed to cover the surface of the anode separator 206 on the anode electrode side (accordingly, the groove (concave part) which forms the fuel channel 208). The first layer 221 has a function of appropriately controlling (restricting) and uniformizing the quantity or the concentration of vaporized fuel which is supplied to the anode electrode 202. When the first layer 221 is provided, crossover of the fuel can be effectively suppressed, and thus temperature unevenness does not easily occur in the power generation unit and a stabilized power generation state can be maintained.

The first layer 221 is not particularly limited as long as it has a gas-liquid separation function with regard to fuel to be used. Examples thereof include porous membranes or porous sheets formed from fluororesins such as polytetrafluoroethylene (PTFE) and polyvinylidene fluoride or silicone resins subjected to a water-repellent treatment. Specific examples thereof include “NTF2026A-N06” and “NTF2122A-S06” of TEMISH (registered trademark) manufactured by Nitto Denko Corporation, which is a porous film formed from polytetrafluoroethylene.

From the viewpoint of imparting the vaporized fuel permeability and the liquid fuel impermeability, the maximum pore diameter of the pores of the first layer 221 is preferably 0.1 μm to 10 μm, and more preferably 0.5 μm to 5 μm. The maximum pore diameter can be obtained by measuring a bubble point using methanol or the like as in the case of the second layer 222, which will be described later.

The thickness of the first layer 221 is not particularly limited. However, the thickness is preferably 20 μm or greater, and more preferably 50 μm or greater in order to sufficiently exhibit the functions. In addition, the thickness is preferably 500 μm or less, and more preferably 300 μm or less from the viewpoint of making the fuel cell thinner.

When the intermediate layer 220 is formed of the first layer 221 and the second layer 222, the second layer 222 is disposed to cover the surface of the anode separator 206 on the anode electrode side, and the first layer 221 is stacked on the surface on the anode electrode side (see FIG. 2(b)).

The second layer 222 is a layer in which the bubble point is 30 kPa or greater when methanol is used as a measurement medium. When such a layer is disposed to cover the fuel channel 208, there are, for example, the following advantages.

(i) Since liquid fuel is held in the pores of the second layer 222 using a capillary force, it is possible to prevent by-product gas (CO₂ gas and the like) which is generated in the anode electrode 202 from intruding into the fuel channel 208. Accordingly, it is possible to prevent a reduction in the supply quantity of vaporized fuel to the anode electrode 202 and prevent the inhibition of stable supply of vaporized fuel, and thus the output stability of the fuel cell can be maintained well. In addition, peeling in an interface between the constituent members, occurring due to the intrusion of the by-product gas and the resulting increase in the inner pressure of the fuel channel 208, and destruction of the constituent members can be suppressed, and thus the reliability of the fuel cell can be improved.

(ii) Liquid fuel can be transported into the fuel channel 208 using a capillary force of the second layer 222, and thus the liquid fuel can be supplied in a passive manner. Accordingly, an auxiliary machine such as a pump for sending the liquid fuel can be omitted.

The bubble point is a minimum pressure at which when an air pressure is applied from the back side of the layer (membrane) wet with a liquid medium, the formation of air bubbles on the surface of the layer (membrane) is recognized. The higher the bubble point, the lower the gas permeability. The bubble point ΔP is defined by the following Expression (I):

ΔP [Pa]=4γ cos θ/d

(where γ represents a surface tension [N/m] of the measurement medium, θ represents a contact angle between the material of the layer (membrane) and the measurement medium, and d represents a maximum pore diameter of the layer (membrane)). In the invention, methanol is used as the measurement medium and the bubble point is measured based on JIS K 3832.

The bubble point of the second layer 222 is preferably 50 kPa or greater, and more preferably 100 kPa or greater from the viewpoint of more effectively preventing the intrusion of the by-product gas into the fuel channel 208. As understood from the Expression (I), the bubble point can be controlled by adjusting the contact angle or the pore diameter of the material which is used for the second layer 222.

In order to achieve the bubble point of 30 kPa or greater, the maximum pore diameter of the pores of the second layer 222 is preferably 1 μm or less, and more preferably 0.7 μm or less. The maximum pore diameter is obtained by measuring the bubble point, and as another method, a mercury intrusion method can be used for the measurement. However, in the mercury intrusion method, the measurement can be performed only in a pore distribution of 0.005 μm to 500 μm. Thus, the method is an effective measurement method only in the case where pores which are out of the above range are not present or can be ignored.

Examples of the second layer 222 include porous layers and polymeric membranes formed from polymeric materials, metal materials, or inorganic materials, and specific examples thereof are as follows.

1) Porous layers formed from the following materials: fluororesins such as polyvinylidene fluoride (PVDF) and polytetrafluoroethylene (PTFE); acrylic resins; ABS resins; polyolefin resins such as polyethylene and polypropylene; polyester resins such as polyethylene terephthalate; cellulose resins such as cellulose acetate, cellulose nitrate, and ion-exchange cellulose; nylons; polycarbonate resins; chlorine resins such as polyvinyl chloride; polyetheretherketone; polyether sulfone; glass; ceramics; and metal materials such as stainless steel, titanium, tungsten, nickel, aluminum, and steel. The porous layers may be a foam body, sintered compact, nonwoven fabric, or fiber (glass fiber and the like) formed from the materials.

2) Polymeric membranes formed from the following materials: materials which can be used as an electrolyte membrane material, such as a perfluorosulfonic acid polymer; a styrene graft polymer, a trifluorostyrene derivative copolymer, and a hydrocarbon polymer such as sulfonated polyarylene ether, sulfonated polyetheretherketone, sulfonated polyimide, sulfonated polybenzimidazole, phosphonated polybenzimidazole, and sulfonated polyphosfazen. These polymeric membranes have nano-order pores as gaps between polymers three-dimensionally interwinded to each other.

When using a polymeric material as a material of the second layer 222, a hydrophilization treatment is performed through a method of introducing a hydrophilic functional group, to increase wettability of the pore surface with respect to water (accordingly, fuel such as methanol or an aqueous methanol solution), whereby the bubble point of the second layer 222 can be increased.

The thickness of the second layer 222 is not particularly limited. However, from the viewpoint of making the fuel cell thinner, the thickness is preferably 20 μm to 500 μm, and more preferably 50 μm to 200 μm.

Examples of the alcohol fuel which is supplied to the direct alcohol fuel cell include alcohols such as methanol and ethanol and aqueous solutions thereof. The alcohol fuel is not limited to one kind, and may be a mixture of two or more kinds. An aqueous methanol solution or pure methanol is preferably used in view of low cost, a high energy density per volume, high power generation efficiency, and the like. As the oxidant gas, for example, O₂ gas, O₂-containing gas such as the air, and the like can be used. Among them, the air is preferably used.

The fuel cell unit 101 may include two or more direct alcohol fuel cells. The two or more direct alcohol fuel cells may be electrically connected in series or in parallel, or the fuel cell unit 101 may include some direct alcohol fuel cells connected in series and some direct alcohol fuel cells connected in parallel. For example, a fuel cell stack in which a plurality of single cells are stacked in series as illustrated in FIG. 2, a planar integrated cell in which a plurality of single cells illustrated in FIG. 2 are disposed on the same plane and electrically connected in parallel, and a fuel cell stack in which a plurality of the planar integrated cells are stacked in series can be exemplified.

(Fuel Supply Unit and Oxidant Supply Unit)

The fuel supply unit 102 is a part for supplying alcohol fuel to the anode electrode of the direct alcohol fuel cell, has at least a flow rate adjuster for adjusting a quantity of alcohol fuel to be supplied to the anode electrode, and generally, further includes a pipe which connects, for example, an alcohol fuel source (an alcohol fuel accommodation tank or the like) and the anode side of the fuel cell (more specifically, the fuel channel of the anode separator). The flow rate adjuster is represented by a liquid sending pump, and in addition to or in place of this, a flow rate adjusting valve or the like installed in the pipe may be used.

The oxidant supply unit 103 is a part for supplying oxidant gas to the cathode electrode of the direct alcohol fuel cell, and may be, for example, a blower or an air sending pump which promotes the introduction of oxidant gas (the air in the atmosphere and the like) to the cathode electrode. If necessary, a pipe which is connected to an entrance of the oxidant gas channel of the cathode separator may be included. The oxidant supply unit 103 is not needed when the air is taken from the cathode electrode side in a passive manner through natural diffusion of the air.

(Detecting Unit)

The detecting unit 104 is a part which is connected to the fuel cell unit 101 and detects a current value I of a current flowing between the anode electrode and the cathode electrode of the direct alcohol fuel cell or an output voltage value V of the direct alcohol fuel cell, and a temperature T of the direct alcohol fuel cell. The current value I can be measured using an ammeter or a tester which is generally used. Preferably, an ammeter which is directly installed in a circuit and is able to always measure an amount of current is used. The output voltage value V can be measured using a voltmeter or a tester which is generally used. Preferably, a voltmeter which is directly installed in parallel in a circuit and is able to always measure a voltage is used. A thermometer for detecting the temperature T may be a conventionally known thermometer.

As described above, the fuel cell unit 101 may include two or more direct alcohol fuel cells. In this case, the current value I and the output voltage value V may be measured for each of the direct alcohol fuel cells. However, from the viewpoint of the connection relationship and easiness of control, it is preferable that two or more direct alcohol fuel cells are regarded as one fuel cell and the current value I and the output voltage value V as a whole are measured.

(Control Unit)

The control unit 105 is a part for determining a supply quantity Q which is a minimum fuel supply quantity required for the cell reaction on the basis of a detection result signal (the current value I or the output voltage value V, and the temperature T) which is output from the detecting unit 104, and for controlling the fuel supply unit 102 so that the supply quantity of the alcohol fuel is adjusted to the supply quantity Q. The control unit 105 is connected to the fuel supply unit 102 and the detecting unit 104. The control unit 105 is not particularly limited, and for example, a personal computer or the like can be used.

(Other Constituent Parts)

The direct alcohol fuel cell system of this embodiment may include other constituent parts other than the above-described parts (this is the same in other embodiments which will be described later). Examples of other constituent parts include a fuel discharge unit for discharging the fuel passing through the anode separator of the fuel cell to the outside of the fuel cell, an oxidant discharge unit for discharging the oxidant gas passing through the cathode separator to the outside, and a recycling pipe for returning the fuel discharged from the fuel cell unit to the fuel supply unit.

### [b] Control of Alcohol Fuel Supply Quantity

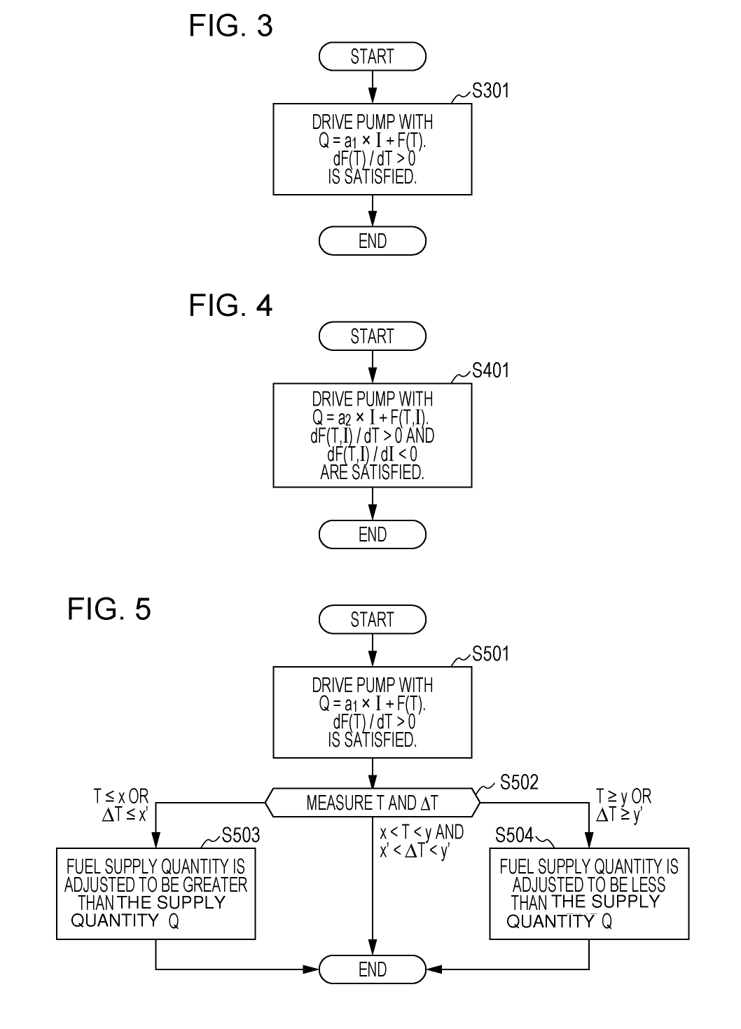

Next, the control of an alcohol fuel supply quantity which is performed by the direct alcohol fuel cell system of this embodiment will be described. FIG. 3 is a flowchart illustrating an example of the control of an alcohol fuel supply quantity which is performed by the direct alcohol fuel cell system of this embodiment. In the control flow illustrated in FIG. 3, the control unit 105 determines, from the detection results of a current value I (unit: A) of a current flowing between the anode electrode and the cathode electrode of the direct alcohol fuel cell and a temperature T (unit: ° C.) of the direct alcohol fuel cell, which are obtained by the detecting unit 104, the supply quantity Q of the alcohol fuel to the anode electrode in accordance with the following Expression [1]:

Q (μmol/s)=a₁×I+F(T)

(where a₁ represents a positive number, and F(T) represents a function of the temperature T which satisfies dF(T)/dT>0),

and controls the fuel supply unit 102 so that the supply quantity of the alcohol fuel is adjusted to the supply quantity Q (Step S301). Specifically, when the flow rate adjuster of the fuel supply unit 102 is a liquid sending pump, a degree of driving the pump is increased or reduced.

When the detecting unit 104 detects an output voltage value V (unit: V) of the direct alcohol fuel cell in place of the current value I, the supply quantity Q of the alcohol fuel to the anode electrode is determined in accordance with the following Expression [2]:

Q (μmol/s)=F′(V)+F(T)

(where F′(V) represents a function of the output voltage value V which satisfies dF′(V)/dV<0, and F(T) represents a function of the temperature T which satisfies dF(T)/dT>0),

and the fuel supply unit 102 is controlled so that the supply quantity of the alcohol fuel is adjusted to the supply quantity Q.

The Expressions [1] and [2] derive, as the supply quantity Q, a minimum alcohol fuel quantity required for the cell reaction based on the considerations that crossover of the alcohol fuel occurs and a crossover quantity increases with a rise in temperature. That is, in the Expression [1], a₁×I means a quantity of alcohol fuel consumed by the power generation of the fuel cell and indicates that the consumption quantity is proportional to the current value I. In addition, when using a relationship I=g(V) between the current and the output voltage of the fuel cell, a₁×I in the Expression [1] may be a₁×g(V), and furthermore, F′(V)=a₁×g(V) may be provided in relation to the Expression (2). Generally, in the relationship I=g(V) between the current and the output voltage of the fuel cell, based on the fact that there is a relationship in which the output voltage is reduced with an increase in the current, F′(V) in the Expression [2] means a quantity of alcohol fuel consumed by the power generation of the fuel cell and indicates that the consumption quantity is reduced with an increase in the output voltage value V.

F(T) means a crossover quantity of the alcohol fuel and indicates that the crossover quantity increases with a rise of the temperature T. F(T) means that the fuel supply quantity is increased by the crossover quantity at that temperature.

In consideration of the crossover quantity having temperature dependency, the supply quantity Q is caused to have the temperature dependency as well as dependency on the current value I or the output voltage value V, and thus a fuel shortage can be prevented. In addition, since the supply quantity Q to be calculated is a minimum alcohol fuel quantity required for the cell reaction, excessive supply of the fuel can also be prevented by adjusting the fuel supply quantity to the supply quantity Q. Furthermore, since the fuel can be supplied neither too much nor too less, the fuel cell can be stably operated.

In the Expression [1], the proportionality constant a₁ is determined in accordance with the kind of the alcohol fuel. For example, when the alcohol fuel is methanol, 6 mols of electrons are generated from an electrochemical reaction of 1 mol of methanol, and thus a₁ can be determined as 1.73 (μmol/A·s). When calculating the supply volume flow rate of the alcohol fuel, it is necessary to determine the supply volume flow rate based on this proportionality constant and the mol concentration of the alcohol contained in the alcohol fuel.

In the [2], F′(V) can be determined based on a current-output voltage curve I=g(V) of the fuel cell measured in advance. Since the quantity of alcohol fuel consumed by the power generation of the fuel cell is determined by a₁×I, F′(V)=a₁×g(V) is provided. In some cases, the current-output voltage curve I=g(V) varies with the temperature, and thus a current-output voltage curve I=g(V, T) also considering temperature dependency may be used.

F(T) which represents the crossover quantity is not particularly limited as long as it satisfies dF(T)/dT>0, and examples thereof include a linear function of T such as cT+d and a quadratic function such as eT²+f (example: F(T)=0.01T+0.2). Constants such as c, d, e, and f can be empirically obtained in advance. Generally, the crossover quantity rapidly (for example, in an exponential manner) increases with a rise in temperature. However, when F(T) is a high-dimensional function of T, the fuel supply quantity can be appropriately controlled as described above even when the crossover quantity rapidly increases with a rise in temperature.

FIG. 4 is a flowchart illustrating another example of the control of an alcohol fuel supply quantity which is performed by the direct alcohol fuel cell system of this embodiment. In the control flow illustrated in FIG. 4, the control unit 105 determines, from the detection results of a current value I (unit: A) of a current flowing between the anode electrode and the cathode electrode of the direct alcohol fuel cell and a temperature T (unit: ° C.) of the direct alcohol fuel cell, which are obtained by the detecting unit 104, the supply quantity Q of the alcohol fuel to the anode electrode in accordance with the following Expression [3]:

Q=a₂×I+F(T,I)

(where a₂ represents a positive number, and F(T, I) represents functions of the temperature T and the current value I which satisfy dF(T, I)/dT>0 and dF(T, I)/dI<0), and controls the fuel supply unit 102 so that the supply quantity of the alcohol fuel is adjusted to the supply quantity Q (Step S401). Specifically, when the flow rate adjuster of the fuel supply unit 102 is a liquid sending pump, a degree of driving the pump is increased or reduced.

When the detecting unit 104 detects an output voltage value V (unit: V) of the direct alcohol fuel cell in place of the current value I, the supply quantity Q of the alcohol fuel to the anode electrode is determined in accordance with the following Expression [4]:

Q=F′(V)+F(T,V)

(where F′(V) represents a function of the output voltage value V which satisfies dF′(V)/dV<0, and F(T, V) represents functions of the temperature T and the output voltage value V which satisfy dF(T, V)/dT>0 and dF(T, V)/dV>0),

and the fuel supply unit 102 is controlled so that the supply quantity of the alcohol fuel is adjusted to the supply quantity Q.

The control flow illustrated in FIG. 4 is the same as that illustrated in FIG. 3, except that Expression [3] or [4] is used in place of Expression [1] or [2]. The difference between Expression [3] or [4] and Expression [1] or [2] is that F representing the crossover quantity of the fuel has dependency on the current value I or the output voltage value V as well as temperature dependency. This considers a phenomenon in which when the current value I is increased or the output voltage value V is reduced, and the quantity of fuel consumed by the cell reaction is increased, the crossover quantity is reduced (accordingly, dF(T, I)/dI becomes a negative value and dF(T, V)/dV becomes a positive value). When the crossover quantity is caused to further have dependency on the current value I or the output voltage value V in consideration of such a phenomenon, the fuel supply quantity can be more strictly controlled, and thus this is more advantageous in the stable operation of the fuel cell and the improvement in the fuel use efficiency.

In the Expression [3], the proportionality constant a₂ is determined in accordance with the kind of the alcohol fuel. For example, when the alcohol fuel is methanol, 6 mols of electrons are generated from an electrochemical reaction of 1 mol of methanol, and thus a₂ can be determined as 1.73 (μmol/A·s). When calculating the supply volume flow rate of the alcohol fuel, it is necessary to determine the supply volume flow rate based on this proportionality constant and the mol concentration of the alcohol contained in the alcohol fuel.

In the [4], F′(V) can be determined based on a current-output voltage curve I=g(V) of the fuel cell measured in advance. Since the quantity of alcohol fuel consumed by the power generation of the fuel cell is determined by a₂×I, F′(V)=a₂×g(V) is provided. In some cases, the current-output voltage curve I=g(V) varies with the temperature, and thus a current-output voltage curve I=g(V, T) also considering temperature dependency may be used.

F(T, I) and F(T, V) are not particularly limited as long as these satisfy dF(T, I)/dT>0 and dF(T, I)/dI<0, and dF(T, V)/dT>0 and dF(T, V)/dV>0, respectively. F(T, I) and F(T, V) can be, regarding I or V, a linear or higher-dimensional function, and regarding T, a linear or higher-dimensional function (example: F(T, I)=(2−I)×0.01T). As described above, when F(T, I) and F(T, V) are high-dimensional functions of T, the fuel supply quantity can be appropriately controlled as described above even when the crossover quantity rapidly increases with a rise in temperature.

The above-described control flow of this embodiment is preferably performed repeatedly at fixed time intervals. This is the same in other embodiments which will be described later.

### Second Embodiment

FIG. 5 is a flowchart illustrating an example of the control of an alcohol fuel supply quantity which is performed by a direct alcohol fuel cell system of this embodiment. The control flow according to this embodiment is characterized in that the fuel supply unit 102 is controlled so that the supply quantity of alcohol fuel is adjusted to a supply quantity Q in the same manner as in the first embodiment, and then a temperature T of the direct alcohol fuel cell and a variation ΔT of the temperature T per unit time are detected to adjust a supply quantity of the alcohol fuel (to change the supply quantity of the alcohol fuel from the supply quantity Q, if necessary) based on the detection result to thus control the temperature T and the variation ΔT within predetermined ranges.

In order to exhibit high power generation efficiency and to obtain more stable operation and higher fuel use efficiency, it is desirable to operate the direct alcohol fuel cell within a predetermined temperature range. When the temperature is excessively low, the power generation efficiency is reduced, and when the temperature is excessively high, the stable operation of the fuel cell is disrupted and the fuel use efficiency is reduced due to an increase in the crossover quantity. The control flow according to this embodiment is provided based on these points. When at least any of the temperature T and the variation ΔT is out of the predetermined range after the supply quantity of the alcohol fuel is controlled to be the supply quantity Q, the supply quantity of the alcohol fuel is changed and adjusted from the supply quantity Q so that the temperature T and the variation ΔT are within the predetermined ranges. The reason for considering the temperature T and the variation ΔT is that in the direct alcohol fuel cell, when the supply quantity of the alcohol fuel is deviated from the appropriate value, temperature fluctuation may occur in a short time at an accelerated pace, that is, for example, thermal runaway occurs due to a positive feedback in which when the temperature of the fuel cell rises due to crossover, the crossover quantity further increases, and thus by adjusting the variation ΔT within a predetermined range, control can be performed rapidly with high accuracy and the stability of the fuel cell can be improved.

The configuration of the direct alcohol fuel cell system according to this embodiment may be the same as that of the first embodiment. However, the detecting unit 104 can detect a variation ΔT of a temperature T per unit time.

The control flow according to this embodiment illustrated in FIG. 5 will be described in detail as follows. First, a supply quantity Q of alcohol fuel to the anode electrode is determined in accordance with any of the Expressions [1] to [4] (FIG. 5 illustrates a case of using Expression [1]) from the detection results of a current value I or an output voltage value V, and a temperature T, which are obtained by the detecting unit 104, and the fuel supply unit 102 is controlled so that the supply quantity of the alcohol fuel is adjusted to the supply quantity Q (Step S501). This step is the same as Step S301 or S401 in the first embodiment.

Next, the temperature T and the variation ΔT are detected (Step S502). It is determined whether the detected T and ΔT are within predetermined ranges of x<T<y and x′<ΔT<y′, respectively, and the control unit 105 controls the fuel supply unit 102 as follows based on the determination results.

(1) When T is equal to or less than x or ΔT is equal to or less than x′, the control unit 105 controls the fuel supply unit 102 for a fixed time so that the supply quantity of the alcohol fuel is greater than the supply quantity Q (Step S503). For example, when the flow rate adjuster of the fuel supply unit 102 is a liquid sending pump, a degree of driving the pump is increased. Accordingly, the crossover quantity of the fuel increases, and thus the temperature T of the fuel cell can be increased.

(2) When T is equal to or greater than y or ΔT is equal to or greater than y′, the control unit 105 controls the fuel supply unit 102 for a fixed time so that the supply quantity of the alcohol fuel is less than the supply quantity Q (Step S504). For example, when the flow rate adjuster of the fuel supply unit 102 is a liquid sending pump, a degree of driving the pump is reduced. Accordingly, the crossover quantity of the fuel is reduced, and thus the temperature T of the fuel cell can be reduced.

It is desirable that x be set to a value of 20° C. or higher and less than 50° C., and preferably 30° C. or higher and less than 40° C. It is desirable that y be set to a value of 40° C. or higher and less than a boiling point of alcohol fuel, and preferably 45° C. or higher and less than a value which is lower than the boiling point of alcohol fuel by 10 degrees. Particularly, the reason for setting a value which is less than the boiling point of alcohol fuel as y is that when the temperature of the fuel cell reaches a temperature which is equal to or higher than the boiling point of alcohol fuel, the alcohol fuel evaporates and it is thus difficult to adjust the supply quantity and to realize the stable operation.

It is desirable that x′ be set to a value of −4° C./min or higher and less than −1° C./min, and preferably −3° C./min or higher and less than −1° C./min. It is desirable that y′ be set to a value of +0.5° C./min or higher and less than +3° C./min, and preferably +1° C./min or higher and less than +2° C./min.

Regarding the change of the fuel supply quantity in the (1) and (2), the increment or decrement of the fuel supply quantity can be appropriately set. In addition, the value of the fuel supply quantity after the change may be a fixed value regardless of the value of the temperature T detected in Step S502, or may depend on the value of the temperature T detected in Step S502.

In the control flow of this embodiment, the temperature of the fuel cell is controlled only by adjusting the fuel supply quantity, and a special auxiliary machine such as a blower is not required to adjust the temperature. Thus, there is an advantage in reducing the size of the fuel cell system.

### Third Embodiment

### [a] Configuration of Direct Alcohol Fuel Cell System

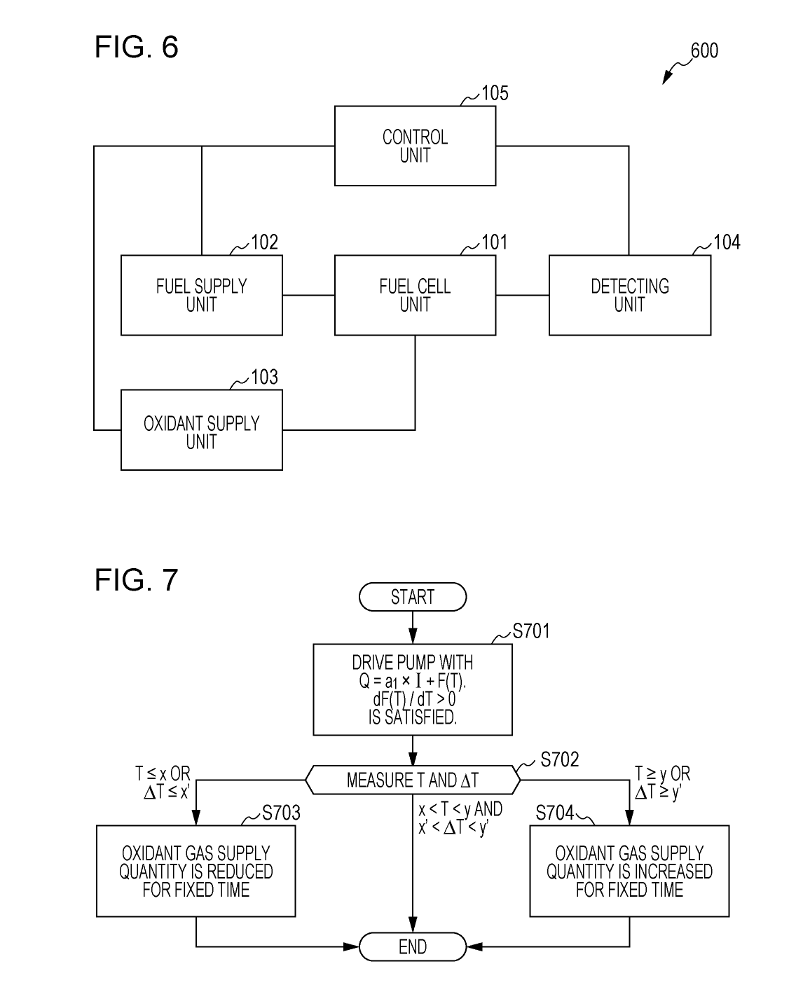

FIG. 6 is a schematic diagram illustrating the configuration of a direct alcohol fuel cell system according to this embodiment. A fuel cell system 600 illustrated in FIG. 6 is the same as the fuel cell system according to the first embodiment, except that an oxidant supply unit 103 and a control unit 105 are further connected to each other, the control unit 105 can further control the adjustment of an oxidant gas supply quantity to the cathode electrode by the oxidant supply unit 103, and a detecting unit 104 can detect a variation ΔT of a temperature T per unit time. As described above, the oxidant supply unit 103 may be a blower or an air sending pump which promotes the introduction of oxidant gas (the air in the atmosphere and the like) to the cathode electrode.

### [b] Control of Alcohol Fuel Supply Quantity

FIG. 7 is a flowchart illustrating an example of the control of an alcohol fuel supply quantity which is performed by the direct alcohol fuel cell system of this embodiment. In the point that an oxidant gas supply quantity is adjusted to adjust a temperature T and a variation ΔT within predetermined ranges, the control flow according to this embodiment is different from that of the second embodiment in which the temperature is controlled by adjusting a fuel supply quantity.

First, a supply quantity Q of alcohol fuel to the anode electrode is determined in accordance with any of the Expressions [1] to [4] (FIG. 7 illustrates a case of using Expression [1]) from the detection results of a current value I or an output voltage value V, and a temperature T, which are obtained by the detecting unit 104, and the fuel supply unit 102 is controlled so that the supply quantity of the alcohol fuel is adjusted to the supply quantity Q (Step S701). This step is the same as Step S301 or S401 in the first embodiment.

Next, the temperature T and the variation ΔT are detected (Step S702). It is determined whether the detected T and ΔT are within predetermined ranges of x<T<y and x′<ΔT<y′, respectively, and the control unit 105 controls the oxidant supply unit 103 as follows based on the determination results.

(1) When T is equal to or less than x or ΔT is equal to or less than x′, the control unit 105 controls the oxidant supply unit 103 for a fixed time so that the supply quantity of the oxidant gas is reduced (is less than a preset oxidant gas supply quantity) (Step S703). For example, when the oxidant supply unit 103 is a blower, a degree of driving the blower is reduced. Accordingly, a cooling effect occurring by the flowing oxidant gas is reduced, and thus the temperature T of the fuel cell can be increased.

(2) When T is equal to or greater than y or ΔT is equal to or greater than y′, the control unit 105 controls the oxidant supply unit 103 for a fixed time so that the supply quantity of the oxidant gas is increased (is greater than a preset oxidant gas supply quantity) (Step S704). For example, when the oxidant supply unit 103 is a blower, a degree of driving the blower is increased. Accordingly, the cooling effect is increased, and thus the temperature T of the fuel cell can be reduced.

In the control flow of this embodiment, the temperature of the fuel cell is controlled only by adjusting the oxidant gas supply quantity. The adjustment of the oxidant gas supply quantity does not affect the supply of the fuel, and thus the fuel cell can be more stably operated. In addition, the fuel use efficiency is more excellent as compared to the control in which the temperature is increased by increasing a crossover quantity.

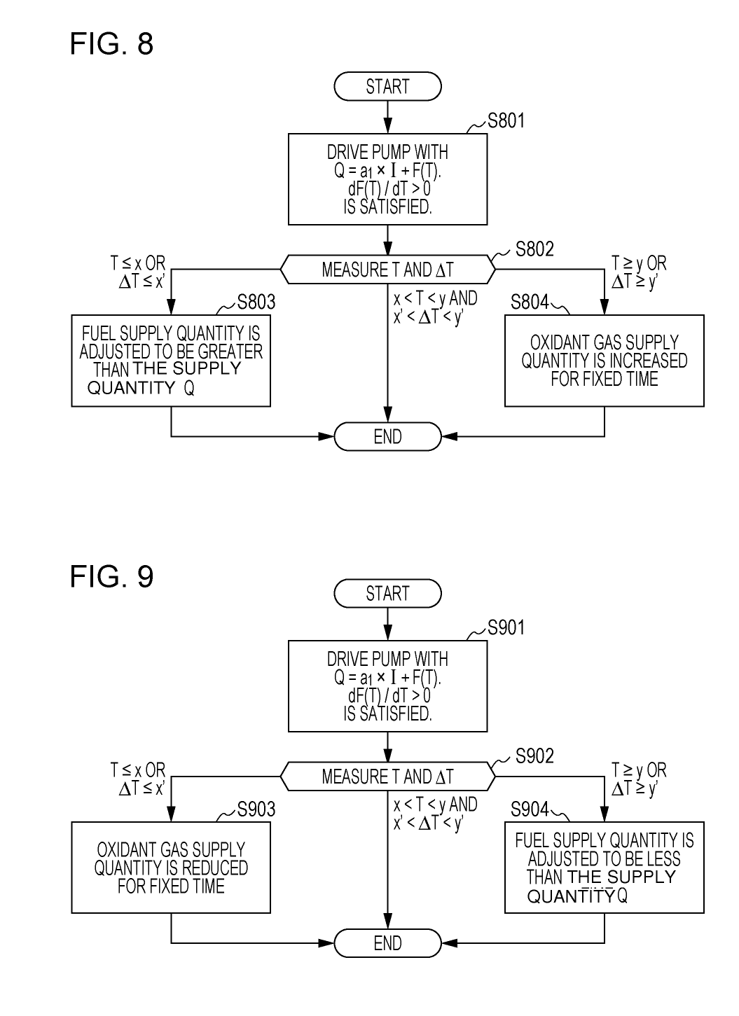

Next, modified examples of the control flow of this embodiment, which are illustrated in FIGS. 8 and 9, will be described. The modified examples in FIGS. 8 and 9 are characterized in that the control flow includes both of the adjustment of a fuel supply quantity and the adjustment of an oxidant gas supply quantity to adjust a temperature T and a variation ΔT within predetermined ranges.

The modified example of FIG. 8 is characterized in that when T is equal to or less than x or ΔT is equal to or less than x′, the fuel supply unit 102 is controlled for a fixed time so that the supply quantity of alcohol fuel is greater than a supply quantity Q (Step S803), and when T is equal to or greater than y or ΔT is equal to or greater than y′, the oxidant supply unit 103 is controlled for a fixed time so that the supply quantity of oxidant gas is increased (is greater than a preset oxidant gas supply quantity) (Step S804). According to such a control flow, the step of reducing the fuel supply quantity or the oxidant gas supply quantity is removed, and thus it is possible to eliminate the possibility of an insufficient supply of fuel or oxidant gas when the temperature is controlled.

The modified example of FIG. 9 is characterized in that when T is equal to or less than x or ΔT is equal to or less than x′, the oxidant supply unit 103 is controlled for a fixed time so that the supply quantity of oxidant gas is reduced (is less than a preset oxidant gas supply quantity) (Step S903), and when T is equal to or greater than y or ΔT is equal to or greater than y′, the fuel supply unit 102 is controlled for a fixed time so that the supply quantity of alcohol fuel is less than the supply quantity Q (Step S904). According to such a control flow, the step of increasing the fuel supply quantity or the oxidant gas supply quantity is removed, and thus there is an advantage in terms of suppression of an increase in power consumption of the pump and the blower. In addition, the fuel use efficiency is more excellent as compared to the control in which the temperature is increased by increasing a crossover quantity, similarly to the control flow illustrated in FIG. 7.

### EXAMPLES

Hereinafter, the invention will be described in more detail with examples. However, the invention is not limited to the examples.

### Production of Direct Alcohol Fuel Cell System

### Example 1

A direct alcohol fuel cell having a configuration similar to that of FIG. 2(b) was produced in the following procedures, and a direct alcohol fuel cell system was produced using the direct alcohol fuel cell.

(1) Production of Membrane Electrode Assembly

Catalyst-carrying carbon particles (TEC66E50, manufactured by Tanaka Kikinzoku Kogyo) with a Pt carrying quantity of 32.5 wt % and a Ru carrying quantity of 16.9 wt %, an alcohol solution (manufactured by Sigma-Aldrich Co. LLC.) containing 20 wt % of Nafion (registered trademark) as an electrolyte, n-propanol, isopropanol, and zirconia balls were put into a container formed from a fluororesin in predetermined proportions and mixed for 50 minutes at 500 rpm using a stirrer to produce a catalyst paste for an anode electrode 202. In addition, a catalyst paste for a cathode electrode 203 was produced in the same manner as in the case of the catalyst paste for the anode electrode, except that catalyst-carrying carbon particles (TEC10E50E, manufactured by Tanaka Kikinzoku Kogyo) with a Pt carrying quantity of 46.8 wt % were used.

Carbon paper (25BC, manufactured by SGL Group) having a water-repellent porous layer formed on one surface was cut to have a length of 23 mm and a width of 28 mm. Subsequently, the catalyst paste for the anode electrode was applied on the porous layer using a screen printing plate having a window having a length of 22 mm and a width of 27 mm so that a catalyst carrying quantity was approximately 3 mg/cm², and was dried. Thus, the anode electrode 202 having a thickness of approximately 100 μm, in which the anode catalyst layer was formed at the center on the carbon paper serving as an anode gas diffusion layer, was produced. In addition, the catalyst paste for the cathode electrode was applied on a porous layer of carbon paper having the same size using a screen printing plate having a window having a length of 22 mm and a width of 27 mm so that a catalyst carrying quantity was approximately 1 mg/cm², and was dried. Thus, the cathode electrode 203 having a thickness of approximately 50 μm, in which the cathode catalyst layer was formed at the center on the carbon paper serving as an cathode gas diffusion layer, was produced.

Next, a perfluorosulfonic acid ion-exchange membrane (Nafion (registered trademark) 117, manufactured by DuPont) having a thickness of approximately 175 μm was cut to have a length of 23 mm and a width of 28 mm, and thus an electrolyte membrane 201 was provided. The anode electrode 202, the electrolyte membrane 201, and the cathode electrode 203 were superposed in this order so that the catalyst layers thereof were opposed to the electrolyte membrane 201, and were bonded to each other by thermocompression bonding for 2 minutes at 130° C. The superposition was performed so that the positions of the anode electrode 202 and the cathode electrode 203 were matched in a surface of the electrolyte membrane and the centers of the anode electrode 202, the electrolyte membrane 201, and the cathode electrode 203 were matched. By cutting an outer circumferential part of the obtained laminate, a membrane electrode assembly 210 having a length of 22 mm and a width of 27 mm was obtained.

(2) Bonding of Collector Layer

A stainless steel plate (NSS445M2, manufactured by Nisshin Steel Co., Ltd.) having a length of 22 mm, a width of 27 mm, and a thickness of 100 μm was prepared. In a central region thereof, a plurality of openings each having a diameter φ of 0.6 mm (opening pattern: zigzag 60°, pitch 0.8 mm) were formed from both sides through wet etching using a photoresist mask. In this manner, two stainless steel plates having a plurality of through holes penetrating therethrough in a thickness direction were produced and provided as an anode collector layer 204 and a cathode collector layer 205.

Next, the anode collector layer 204 was stacked on the anode electrode 202 with a conductive adhesive layer which was interposed therebetween and formed from carbon particles and an epoxy resin, and the cathode collector layer 205 was stacked on the cathode electrode 203 with a conductive adhesive layer which was interposed therebetween and formed from carbon particles and an epoxy resin. These were bonded to each other by thermocompression bonding. The anode collector layer 204 and the cathode collector layer 205 were laminated so that the regions in which the openings were formed were disposed directly on the anode electrode 202 and the cathode electrode 203, respectively.

(3) Production of Intermediate Layer

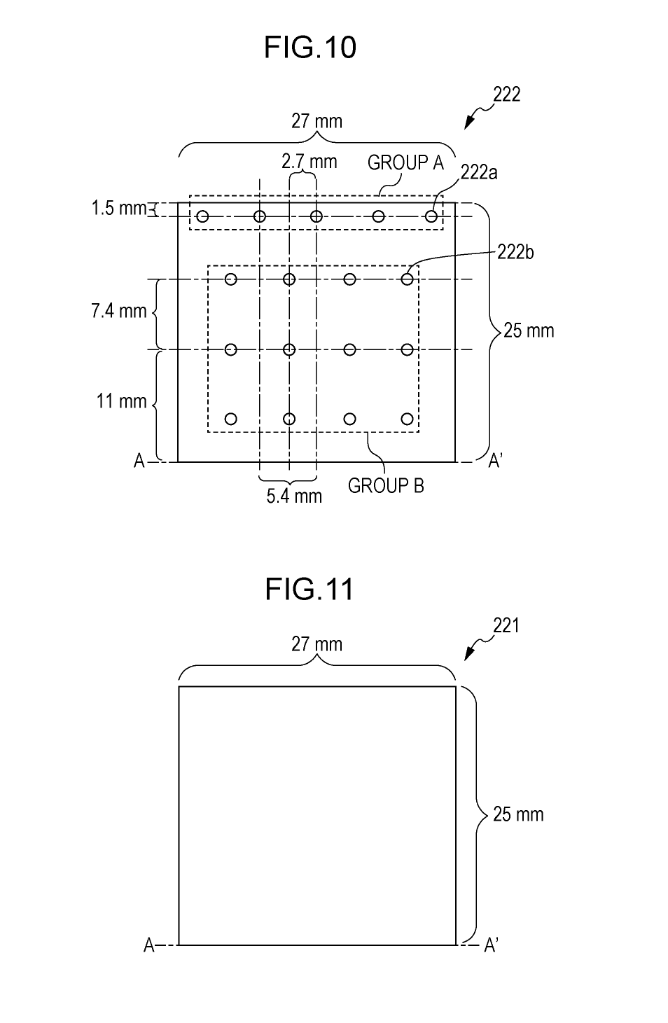

A porous film (Durapore membrane filter manufactured by MILLIPORE) having a length of 25 mm, a width of 27 mm, and a thickness of 0.1 mm, formed from polyvinylidene fluoride, as illustrated in FIG. 10 was used as a second layer 222 of an intermediate layer 220. The maximum pore diameter of pores of this porous film was 0.1 μm, and the bubble point obtained based on JIS K 3832 was 115 kPa when methanol was used as a measurement medium.

As illustrated in FIG. 10, the second layer 222 has through holes 222a (inner diameter 1.0 mm) penetrating therethrough in a thickness direction, which are represented by “hole group A” (five holes included in a region surrounded by a dotted line frame) and through holes 222b (inner diameter 1.0 mm) penetrating therethrough in a thickness direction, which are represented by “hole group B” (twelve holes included in a region surrounded by another dotted line frame). The through holes 222a are holes for removing the air present in a fuel channel 208 when liquid fuel enters into the fuel channel 208 of an anode separator 206 disposed under the second layer 222 (liquid fuel enters by removing the air). When the through holes 222a are provided, the air in the fuel channel 208 can be removed even after the second layer 222 is completely wet with the fuel. Thus, the fuel channel 208 is filled with the liquid fuel without the air staying in the fuel channel 208. Since the membrane electrode assembly 210 is not disposed on the through holes 222a, by-product gas generated in the anode electrode 202 does not intrude into the fuel channel 208 through the through holes 222a. The through holes 222b are through holes for discharging by-product gas to the outside of the fuel cell, and are disposed directly above through holes 206a of the anode separator 206 which will be described later. That is, a by-product gas discharge channel includes the through holes 222b and the through holes 206a connected to the through holes 222b.

In addition, a porous film (“TEMISH (registered trademark) NTF2122A-S06” manufactured by Nitto Denko Corporation) having a length of 25 mm, a width of 27 mm, and a thickness of 0.2 mm, formed from polytetrafluoroethylene, as illustrated in FIG. 11 was used as a first layer 221 (gas-liquid separation layer) of the intermediate layer 220. The bubble point of this porous film obtained based on JIS K 3832 was 18 kPa when methanol was used as a measurement medium.

The first layer 221 was stacked on the second layer 222 (stacked so that the A-A′ planes of FIGS. 10 and 11 were matched) and the layer boundary parts of all of side surfaces were bonded with an adhesive to produce the intermediate layer 220.

(4) Bonding Between Anode Separator and Intermediate Layer

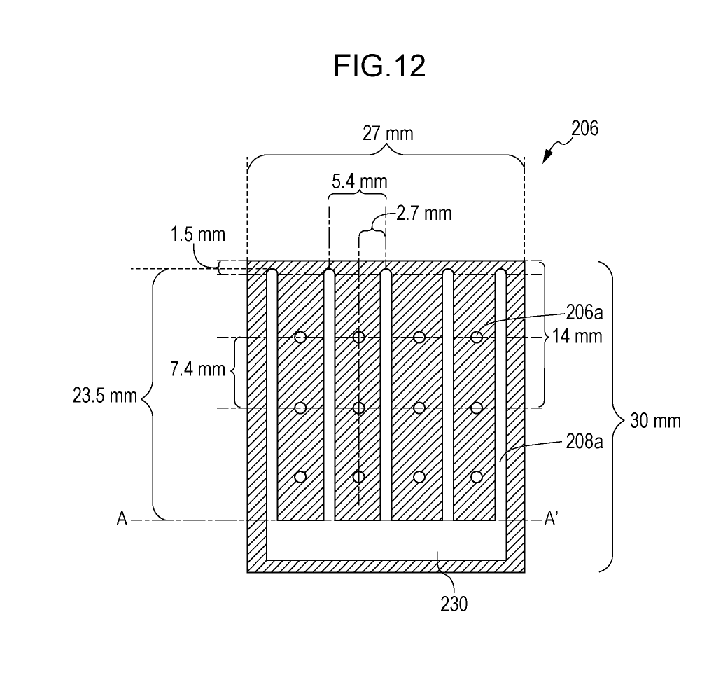

The anode separator 206 having a length of 30 mm, a width of 27 mm, and a thickness of 0.6 mm in which as illustrated in FIG. 12, five channel grooves (fuel channels 208) each having a width of 1.0 mm and a depth of 0.4 mm were formed on one surface and total twelve through holes 206a each having an inner diameter of 1.0 mm were formed at positions illustrated in the drawing, respectively, was provided. This anode separator 206 is provided with, as a part of the channel, a concave part constituting a fuel manifold 230 (a main channel connecting five branched channels) on the side of the fuel channel 208. The intermediate layer 220 was stacked on the channel forming surface of the anode separator 206 with a polyolefin adhesive interposed therebetween (stacked so that the A-A′ planes of FIGS. 10 to 12 were matched) so that the second layer 222 of the intermediate layer 220 was provided on the anode separator side. Subsequently, thermocompression bonding was performed to bond the intermediate layer 220 and the anode separator 206 to each other. The through holes 222b (hole group B) of the second layer 222 are disposed directly above the through holes 206a of the anode separator 206.

(5) Production of Direct Alcohol Fuel Cell

The membrane electrode assembly with the collector layer was stacked on the intermediate layer 220 so that an end surface of the membrane electrode assembly with the collector layer on the long side overlapped with the A-A′ plane of the anode separator-intermediate layer bonded body. Next, using a mask, a coating liquid containing an epoxy resin was applied to both side surfaces (side surfaces parallel to the fuel channel 208) of the membrane electrode assembly with the collector layer, the intermediate layer 220, and the anode separator 206 and was cured for coating with a sealing layer formed from the epoxy resin. Accordingly, it is possible to prevent the air from entering the anode electrode from the outside of the fuel cell or to prevent the fuel from leaking to the outside of the fuel cell. In addition, an epoxy resin was applied to end surfaces of the membrane electrode assembly with the collector layer and the intermediate layer 220 on the fuel manifold side and was cured to form a sealing layer (fuel intrusion prevention layer). Finally, a housing provided with an opening (for pipe connection from a fuel tank) penetrating therethrough in a thickness direction was disposed on the fuel manifold 230 to obtain a direct alcohol fuel cell.

(6) Production of Direct Alcohol Fuel Cell System

The produced direct alcohol fuel cell was used as a fuel cell unit 101 to produce a fuel cell system having a configuration similar to that of FIG. 1. The specific description thereof is as follows.

A liquid sending pump (connected to the fuel tank) serving as a fuel supply unit 102 and a pipe made of silicone rubber were connected to be able to supply alcohol fuel to the anode separator 206 of the fuel cell unit 101, and a blower serving as an oxidant supply unit 103 was disposed to be opposed to the cathode collector layer 205 so as to supply the air to the cathode electrode 203 of the fuel cell unit 101. A temperature sensor serving as a detecting unit 104 was installed in the vicinity of the membrane electrode assembly 210 of the direct alcohol fuel cell, and an ammeter and a voltmeter were connected to the anode collector layer 204 and the cathode collector layer 205 (the ammeter was connected to the fuel cell in series and the voltmeter was connected to the fuel cell in parallel). In addition, a personal computer serving as a control unit 105 was connected to the detecting unit 104 to be able to receive an electric signal from the detecting unit 104, and was connected to the fuel supply unit 102 to transmit control information to the fuel supply unit 102 based on the information from the detecting unit 104. A temperature variation ΔT per unit time was calculated by subjecting the temperature measured by the detecting unit 104 to arithmetic processing with the control unit 105.

An aqueous methanol solution (concentration 15 mol/L) as fuel was supplied to the anode separator 206 using a liquid sending pump, and the air was supplied to the cathode electrode 203 using a blower to operate the obtained fuel cell system in accordance with the control flow illustrated in FIG. 5. In this case, in Step S501, a supply quantity Q of the fuel was determined in accordance with the following expression:

Q (μmol/s)=1.73×I(A)+0.02×T (° C.)

and a degree of driving the liquid sending pump was controlled so that the supply quantity of the aqueous methanol solution was adjusted to the supply quantity Q. In addition, in Steps S503 and S504, the predetermined values x, y, x′, and y′ of the temperature T and the variation ΔT of the temperature T were set as follows: x=35° C., y=45° C., x′=−1° C./min, and y′=+1° C./min.

While the control flow illustrated in FIG. 5 was repeatedly performed, power generation was continuously performed for one and a half hours at a drawing current of 0.5 A (100 mA/cm²). The range of variation in temperature of the direct alcohol fuel cell for one hour, from 30 minutes after the start of the power generation to one and a half hours after the start, was 38° C. to 42° C., and the range of variation in output voltage value was 0.3 V to 0.35 V.

### Example 2

The direct alcohol fuel cell system produced in Example 1 was operated in accordance with the control flow illustrated in FIG. 3. In this case, in Step S301, a supply quantity Q of fuel was determined in accordance with the following expression:

Q (μmol/s)=1.73×I(A)+0.02×T (° C.)

and a degree of driving the liquid sending pump was controlled so that the supply quantity of the aqueous methanol solution was adjusted to the supply quantity Q.

While the control flow illustrated in FIG. 3 was repeatedly performed, power generation was continuously performed for one and a half hours at a drawing current of 0.5 A (100 mA/cm²). The range of variation in temperature of the direct alcohol fuel cell for one hour, from 30 minutes after the start of the power generation to one and a half hours after the start, was 38° C. to 46° C., and the range of variation in output voltage value was 0.27 V to 0.33 V.

### Example 3

The direct alcohol fuel cell system produced in Example 1 was operated in accordance with the control flow illustrated in FIG. 4. In this case, in Step S401, a supply quantity Q of fuel was determined in accordance with the following expression:

Q (μmol/s)=1.73×I(A)+{2−I[A]}×0.01×T (° C.)

and a degree of driving the liquid sending pump was controlled so that the supply quantity of the aqueous methanol solution was adjusted to the supply quantity Q.

While the control flow illustrated in FIG. 4 was repeatedly performed, power generation was continuously performed for one and a half hours at a drawing current of 0.5 A (100 mA/cm²). The range of variation in temperature of the direct alcohol fuel cell for one hour, from 30 minutes after the start of the power generation to one and a half hours after the start, was 38° C. to 44° C., and the range of variation in output voltage value was 0.29 V to 0.34 V.

### Comparative Example 1

A direct alcohol fuel cell system was produced in the same manner as in Example 1, except that a control unit 105 was configured to determine a supply quantity Q based only on a current value I and to be able to control a fuel supply unit 102 so that a supply quantity of an aqueous methanol solution was adjusted to the supply quantity Q (that is, a temperature sensor and the control unit 105 were not connected).

An aqueous methanol solution (concentration 15 mol/L) as fuel was supplied to an anode separator 206 using a liquid sending pump, and the air was supplied to a cathode electrode 203 using a blower to operate the obtained fuel cell system in the same manner as in Example 1. However, in Step S501, a supply quantity Q of the fuel was determined based only on the current value I in accordance with the following expression:

Q (μmol/s)=1.73×I(A)

and a degree of driving the liquid sending pump was controlled so that the supply quantity of the aqueous methanol solution was adjusted to the supply quantity Q. In addition, Steps S502 to S504 were not carried out.

While such a control flow was repeatedly performed, power generation was continuously performed for one and a half hours at a drawing current of 0.5 A (100 mA/cm²). The range of variation in temperature of the direct alcohol fuel cell for one hour, from 30 minutes after the start of the power generation to after one and a half hours after the start, was 33° C. to 42° C., and the range of variation in output voltage value was 0.20 V to 0.33 V.

### REFERENCE SIGNS LIST

100, 600: FUEL CELL SYSTEM, 101: FUEL CELL UNIT, 102: FUEL SUPPLY UNIT, 103: OXIDANT SUPPLY UNIT, 104: DETECTING UNIT, 105: CONTROL UNIT, 200, 200′: DIRECT ALCOHOL FUEL CELL, 201: ELECTROLYTE MEMBRANE, 202: ANODE ELECTRODE, 203: CATHODE ELECTRODE, 204: ANODE COLLECTOR LAYER, 205: CATHODE COLLECTOR LAYER, 206: ANODE SEPARATOR, 206a: THROUGH HOLE, 207: CATHODE SEPARATOR, 208: FUEL CHANNEL, 209: OXIDANT GAS CHANNEL, 210: MEMBRANE ELECTRODE ASSEMBLY, 220: INTERMEDIATE LAYER, 221: FIRST LAYER, 222: SECOND LAYER, 222a, 222b: THROUGH HOLE, 230: FUEL MANIFOLD

1. A direct alcohol fuel cell system comprising:
a fuel cell unit which includes a direct alcohol fuel cell including an anode electrode, an electrolyte membrane, and a cathode electrode in this order;
a fuel supply unit for supplying alcohol fuel to the anode electrode;
a detecting unit for detecting a current value I of a current flowing between the anode electrode and the cathode electrode of the direct alcohol fuel cell or an output voltage value V of the direct alcohol fuel cell, and a temperature T of the direct alcohol fuel cell; and
a control unit for determining a supply quantity Q of alcohol fuel to the anode electrode based on detection results of the current value I or the output voltage value V, and the temperature T and controlling the fuel supply unit so that the supply quantity of the alcohol fuel is adjusted to the supply quantity Q.

2. The direct alcohol fuel cell system according to claim 1,
wherein the detecting unit can further detect a variation ΔT of the temperature T per unit time, and
wherein when at least one of the temperature T and the variation ΔT which are detected after the fuel supply unit is controlled so that the supply quantity of the alcohol fuel is adjusted to the supply quantity Q is out of a predetermined range, the control unit controls the fuel supply unit to change the supply quantity of the alcohol fuel from the supply quantity Q so that the temperature T and the variation ΔT are within the predetermined ranges.

3. The direct alcohol fuel cell system according to claim 1, further comprising: an oxidant supply unit for supplying oxidant gas to the cathode electrode,
wherein the detecting unit can further detect a variation ΔT of the temperature T per unit time,
wherein the control unit can further control the adjustment of the supply quantity of the oxidant gas to the cathode electrode by the oxidant supply unit, and
wherein when at least one of the temperature T and the variation ΔT which are detected after the fuel supply unit is controlled so that the supply quantity of the alcohol fuel is adjusted to the supply quantity Q is out of a predetermined range, the control unit controls the fuel supply unit to change the supply quantity of the alcohol fuel from the supply quantity Q so that the temperature T and the variation ΔT are within the predetermined ranges, and/or controls the oxidant supply unit to change the supply quantity of the oxidant gas.

4. The direct alcohol fuel cell system according to claim 1,
wherein the control unit determines the supply quantity Q of the alcohol fuel in accordance with the following Expression [1]:
Q=a₁×I+F(T)
(where a₁ represents a positive number, and F(T) represents a function of the temperature T which satisfies dF(T)/dT>0) or the following Expression [2]:
Q=F′(V)+F(T)
(where F′(V) represents a function of the output voltage value V which satisfies dF′(V)/dV<0, and F(T) represents a function of the temperature T which satisfies dF(T)/dT>0).

5. The direct alcohol fuel cell system according to claim 1,
wherein the control unit determines the supply quantity Q of the alcohol fuel in accordance with the following Expression [3]:
Q=a₂×I+F(T,I)
(where a₂ represents a positive number, and F(T, I) represents functions of the temperature T and the current value I which satisfy dF(T, I)/dT>0 and dF(T, I)/dI<0) or the following Expression [4]:
Q=F′(V)+F(T,V)
(where F′(V) represents a function of the output voltage value V which satisfies dF′(V)/dV<0, and F(T, V) represents functions of the temperature T and the output voltage value V which satisfy dF(T, V)/dT>0 and dF(T, V)/dV>0).

6. The direct alcohol fuel cell system according to claim 1,
wherein the alcohol fuel is methanol or an aqueous solution thereof, and the oxidant gas is the air.
